(19) United States
(12) Patent Application Publication
(10) Pub. No.: US 2004/0103433 A1
(43) Pub. Date: May 27, 2004

(54) Search method for audio-visual programmes or contents on an audio-visual flux containing tables of events distributed by a database

(76) Inventors: Yvan Regeard, Cesson-Sevigne (FR); Cathy Benguigui, Domagne (FR); Christophe Cutullic, Domloup (FR); Eric Bayet, Nouvoitou (FR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(21) Appl. No.: 10/363,934

(22) PCT Filed: Sep. 7, 2001
(86) PCT No.: PCT/FR01/02788

(30) Foreign Application Priority Data
Sep. 7, 2000 (FR) 00/11436

(51) Int. Cl. G06F 7/00; G06F 17/30; G06F 3/00; H04N 5/445; G06F 13/00; H04N 7/173

(52) U.S. Cl. 725/53; 725/109; 725/112; 707/3; 707/4; 707/7

(57) ABSTRACT

An internet on-demand system for television presents internet content and traditional television programming as part of a single coherent interface. The system includes a server and a client capable of providing a dynamic graphical user interface. The system can display an internet gateway interface which actively scrolls through and highlights links to selectd web pages which are organized according to templates corresponding to their content. the web pages are presented on the graphical user interface as channel as part of the same milieu as channels of traditional television programming. the user can select a channel from a rotary menu wheel or via channel-up, channel-down buttons on the remote control device. An intelligent agent passively filters selected web pages for a user to explore based on the user's past pattern of usage of the client. The server queries the client regarding its available data stream connections, including telephone modems, cable modems, wireless telecommunications and digital satellite broadcasting, regarding its ability to detect embedded data in TV signals, in order to determine the most efficient delivery of different types of data through all of the available bandwidth connections for both directions of data flow. The efficient delivery of data allows the client to present text, graphics, video, audio and other multimedia

The invention concerns the field of multimedia applications used in an audio-visual context, and more particularly the search methods for audio-visual programs and contents in a distributed flux, by means of electronic program guides for example. It also concerns searching for multimedia data on Internet-type dedicated servers, also called program databases, and the combination of these two search types.

The current electronic program guides offer a conventional search by selection on theme/channel/day/broadcast time, little suited to sorting in a large and continually growing program offering (e.g. 150 satellite television broadcasting channels).

Search by keyword is a function commonly used by Internet search engines, which do not address and therefore do not allow either searching or selecting audio-visual contents.

The previous technique (conventional search by single or multiple criteria selection) does not allow a sufficiently selective sort when the program offering is varied and large. In addition, the themes are fixed, which only allows minor customization of the search.

Finally, only the television broadcast data are used, in the absence of using an interactive channel.

One object of the present invention is the implementation of a method for:

improving the existing techniques,

limiting the number of responses to the most relevant, which well suits the display constraints on a television set, TV set,

offering the user an easy and efficient method of customizing his/her program search,

transparent enrichment of distributed data via complementary data.

Another object of the present invention is the implementation of a method for selecting audio-visual contents meeting precise criteria with the following functionalities:

display of images corresponding to the selection in the form of a ticker tape,

display of sufficient text information for guiding the user's choice,

display of animated sequences (trailers), or direct connection onto the selected television broadcast,

direct access to 2^{nd} level information: summaries, reviews, files, or trailers accessible via on-line or television broadcast link.

The search method for audio-visual programs or contents on an audio-visual flux containing tables of events EIT (Event Information Table) distributed by a database, the object of the present invention, is characterized in that it consists in establishing a search criterion for programs consisting of a combination of all or part of the search arguments such as keywords, search themes, television broadcasting channel, day, broadcast time.

In a non-restrictive manner, these EITs may be broadcast via the Service Information SI defined by the MPEG2 and DVB standards described in particular in documents ISO/IEC 13818-1: “Information Technology—Generic coding of moving pictures and associated audio recommendation H.222.0 (systems)”, EN 300 468: “Digital video broadcasting (DVB)—Specification for Service Information “SI in DVB Systems”, and ETR 211: “Digital video broadcasting (DVB)—Guidelines on implementation and usage of service information”. These standards are incorporated by reference in the present description.

Advantageously, the search method by keyword is coupled with a multicriteria search by theme, channel, day and broadcast time. The method forming the object of the present invention is characterized in that it consists in combining a search by keyword in the different fields of the event tables broadcast in the audio-visual program flux with a search by program guide criteria of the Theme, Channel, Day, Broadcast Time type, whose values are defined in said event tables, for accessing textual contents of a database accessible via an interactive link.

The invention is used for searching for audio-visual programs or contents associated with these programs, in a database set up locally based on signaling information from the distributed flux and enabling access to additional multimedia contents.

The invention integrates especially with a program guide type of service and can be used to enrich this with additional multimedia contents.

The method forming the object of the invention is further characterized in that complementary data being associated with the events contained in the event table, it consists in extending the search field of the search argument by keywords to the complementary data for each event.

The method forming the object of the present invention is also characterized in that for a database comprising multimedia contents, the multimedia contents associated with an event are linked to the event selected by a URL-type link stored in an event table, which enables direct access to be established to the associated multimedia contents via the event tables.

The method forming the object of the present invention and finally characterized in that it further consists in displaying images obtained based on the search criterion in the form of a ticker tape, enabling the user to make a preliminary check on the results of the search by user-initiated scrolling of these images.

The invention will be better understood from reading the detailed description of a non-restrictive example relating to the search for audiovisual contents (broadcast programs and complementary data, that is, pre-stored audiovisual contents), and from looking at the drawings in which:

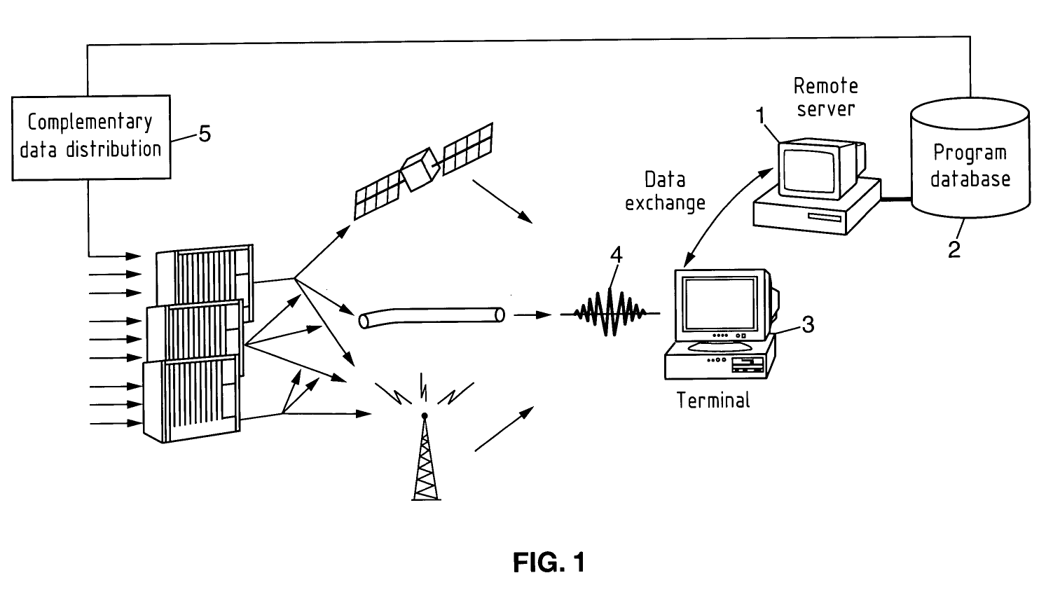

FIG. 1 represents a network architecture illustrating the implementation context of the method of searching for audio-visual programs or contents on an audio-visual flux containing event tables distributed by a database, in accordance with the object of the present invention;

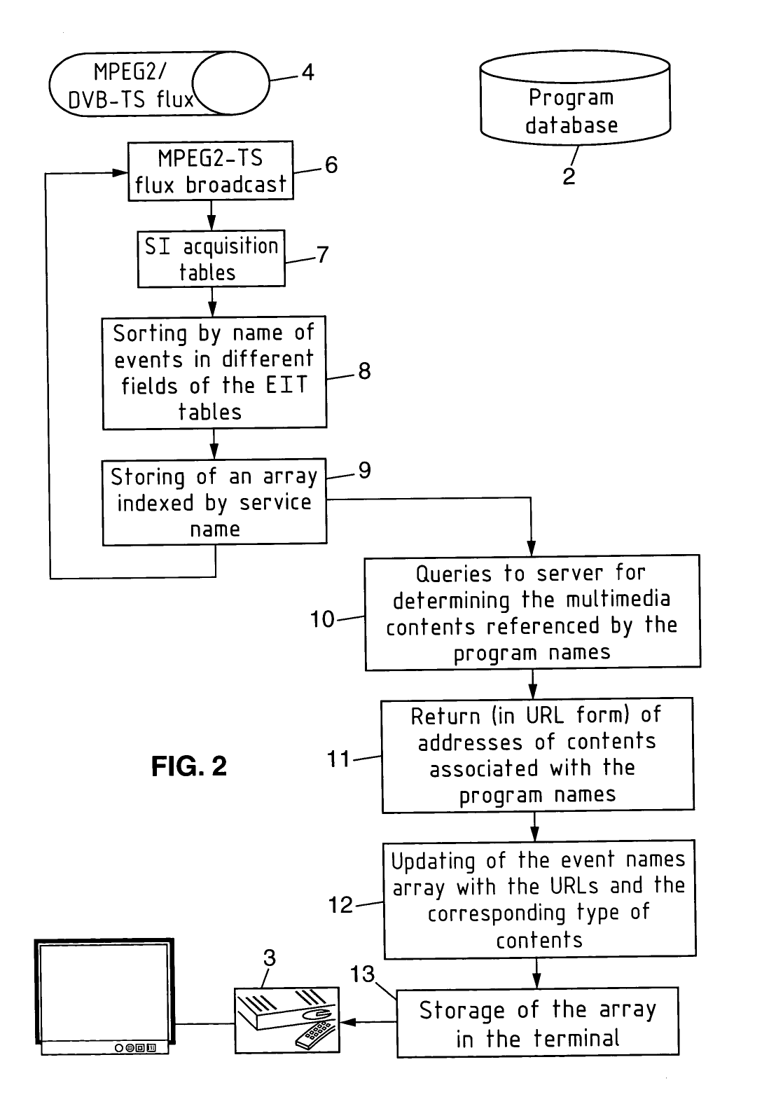

FIG. 2 shows, as a guide, a flow chart of all the steps for implementing the method forming the object of the present invention within the context shown in FIG. 1;

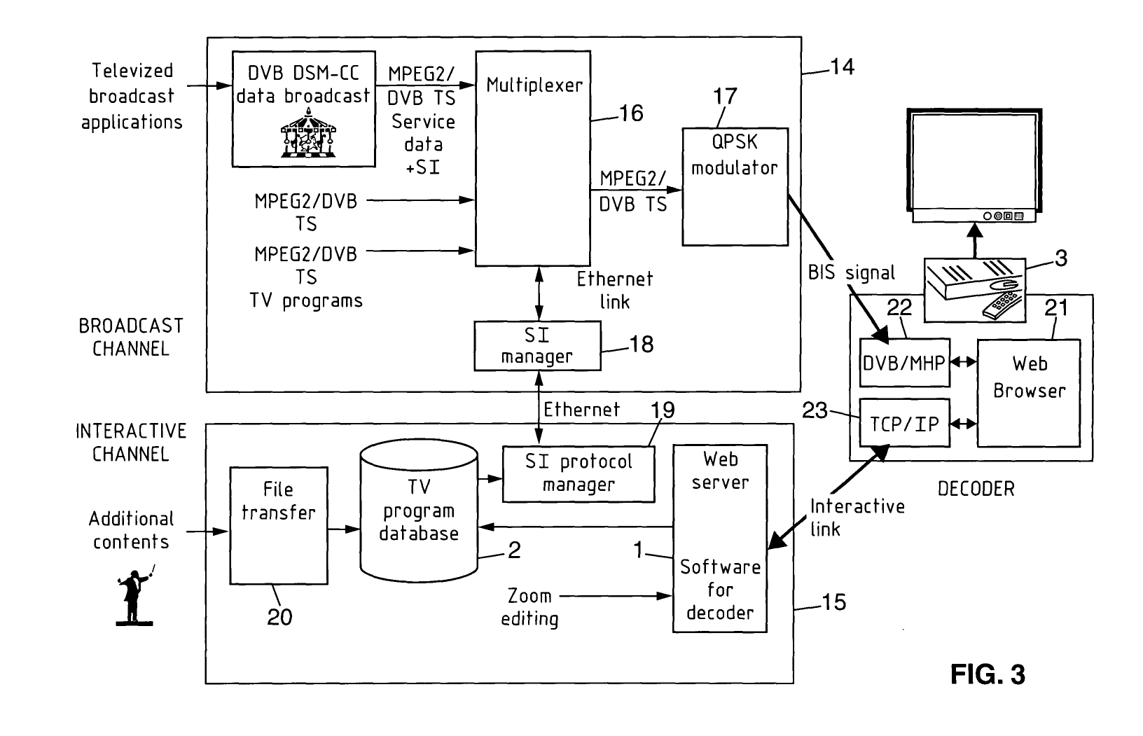

FIG. 3 shows, as a guide, a block diagram of a system of implementation of the method forming the object of the invention;

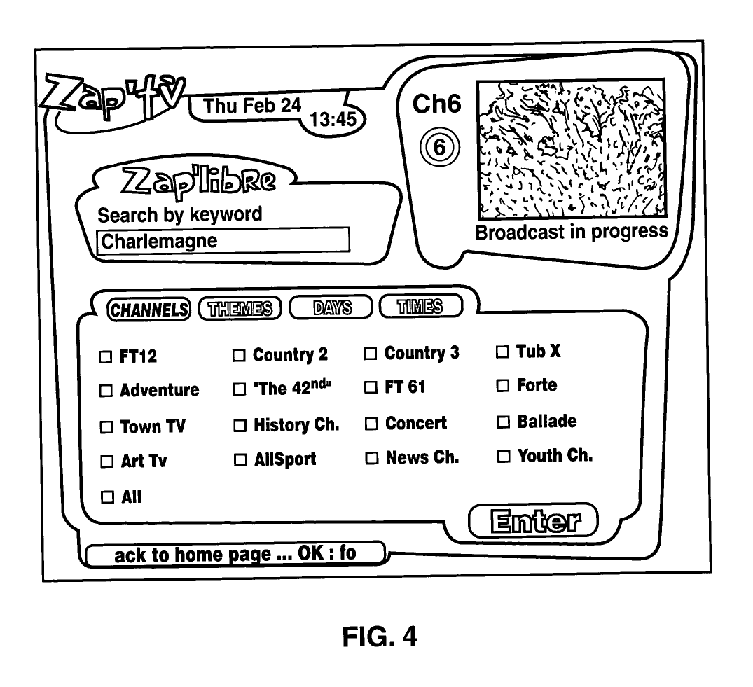

FIG. 4 shows, as a guide, a screen for searching for a program based on a search criterion consisting of a search theme argument such as a selected television broadcasting channel;

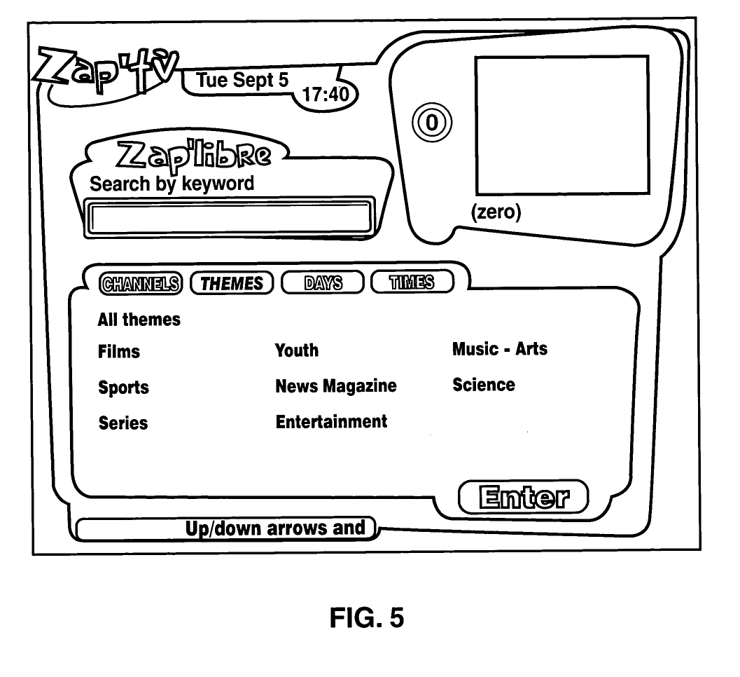

FIG. 5 shows, as a guide, a screen for searching for a program based on a search criterion consisting of a search theme argument such as a thematic subject;

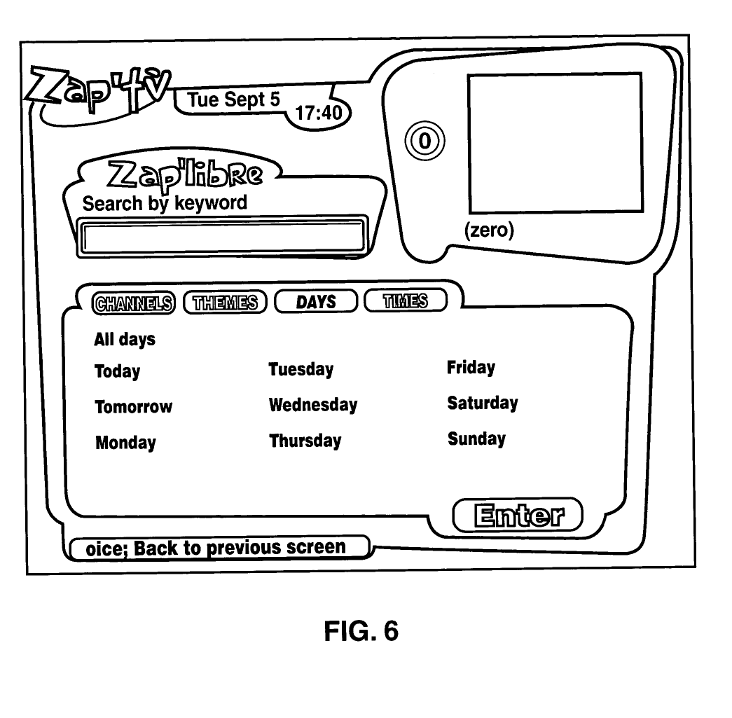

FIG. 6 shows, as a guide, a screen for searching for a program based on a search criterion consisting of a selected day argument;

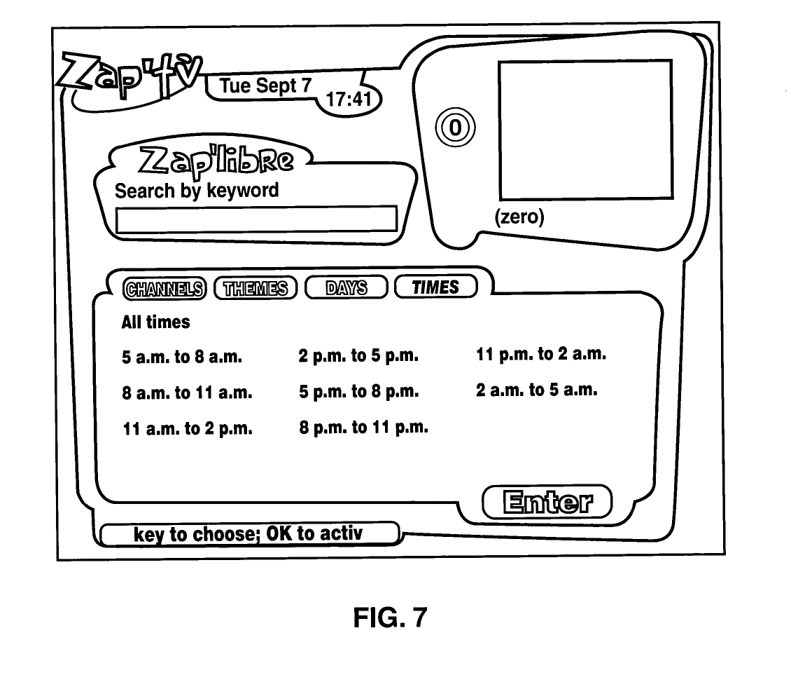

FIG. 7 shows, as a guide, a screen for searching for a program based on a search criterion consisting of a selected times argument;

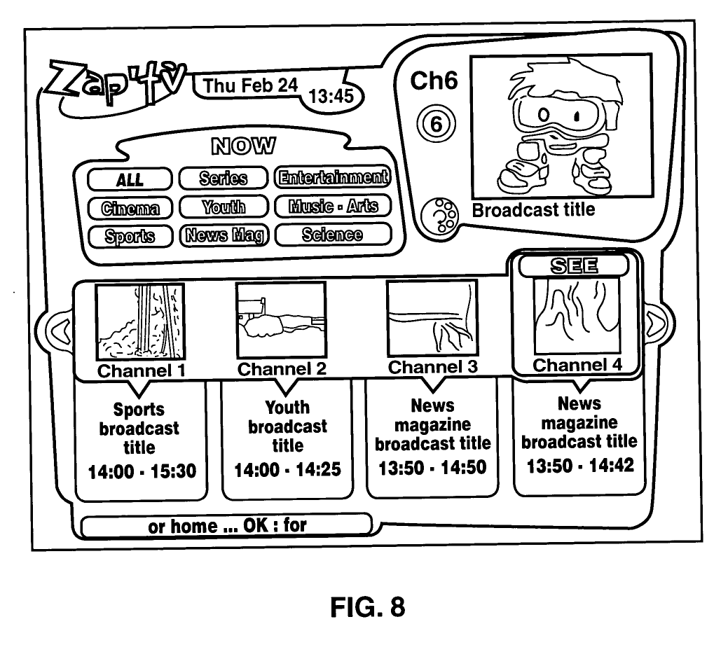

FIG. 8 shows, as a guide, a screen for presenting and displaying images relating to at least one selected program and obtained from the method forming the object of the present invention, this display being preferentially, not restrictively, in the form of a ticker tape for the attention of the user.

With reference to FIG. 1, it is recalled that a program database 2 is set up on a server 1. The server may be local or remote. The database 2 contains the complementary data, defined by information associated with the audio-visual contents: images (image capture during a broadcast), trailer, review, film data sheet, summary, etc.

An array of the events contained in event tables EIT (Event Information Table) of the information system SI present in the distributed flux 4 DVB (Digital Video Broadcasting) is set up and stored in the terminal 3 (cache mode), in order to be able to access information faster.

The EIT tables are described in Appendix 1.

The EIT tables are broadcast cyclically in the broadcast flux signal 4 as shown by step 6 with reference to FIG. 2. A step 7 acquires the EIT tables from the information system SI.

In step 8, events are sorted by name in various fields of the EIT tables acquired in step 7. This enables the storage in step 9 of an array of services indexed by name. Step 9 is looped back to step 6 so as to regularly reiterate steps 7 to 9 to update the contents of the array according to the broadcast in step 6.

In parallel with this, a set of queries is sent to the program database 2 accessible via the server 3, in order to determine, for each event, the possible existence of complementary data of the following types:

an image,

a trailer or associated video (or several),

editorial contents (reviews, summaries, data sheet).

In a step 10, queries are sent to the server 3 for determining the multimedia contents referenced by the program names corresponding to the service names of the array stored in step 9.

In steps 11 and 12, links are then made, in the form of URLs for Universal Resource Locator, between the stored events array and the address of these complementary data in the server.

In step 11, addresses of the contents associated with the program names are returned in the form of URLs.

In step 12, the array is updated by associating the URLs and the corresponding type of content with the names of events.

In a step 13, the array is stored in the terminal 3.

With reference to FIG. 3, there is a piece of equipment 14 for transmitting an audio-visual flux on a broadcast channel and a piece of equipment 15 for exchanging data on an interactive channel.

In the equipment 14, a multiplexer 16 receives at the input several audio-visual fluxes originating from television broadcast applications and television programs. A QPSK modulator 17 receives at the input a DVB or possibly MPEG2 broadcast flux generated at the output of the multiplexer 16. An SI manager 18 accesses the multiplexer 16 by means of an Ethernet link. The modulator 17 is designed to broadcast a BIS signal for implementing step 6.

The equipment 15 includes the server 1 and the database and the database 2. An SI protocol manager 19, in communication with the manager 18 by means of an Ethernet link, receives data from the database 2. A file transfer device 20 enables additional contents to be introduced into the database 2.

The terminal 3 includes a Web browser 21, a DVB/MHP receiver 22 and a TCP/IP interface 23. The browser 21 accesses the receiver 22 and the interface 23 bidirectionally. The receiver 22, receiving the audio-visual flux via the BIS signal, is used to perform steps 6 to 9 of the method. The interface 23 is used for making Internet-type connections with the server 1 on an interactive link, for performing steps 10 to 13.

At the conclusion of the search, all the additional data is therefore easily accessible via the server containing the whole of this remote database.

A screen offers the entry of the following criteria:

keyword (entered via an IR keyboard, speech interface, etc.),

theme (music, documentary, sport, etc.) or thematic subject,

television broadcasting channel,

day,

broadcast time.

Each of the criteria is optional. One or more choices can be selected for each criterion (e.g. several days in the week).

Navigation and confirmation of choices is done via the remote control, using the arrow keys (left, right, up, down) and an Enter key.

### Functional Description of the Search Mechanism by Keywords

### Description of the Program Search Screen

The search allows keywords to be combined with search criteria or arguments, channel, theme, day and time.

The corresponding screen is shown in FIG. 4.

One or more keywords can be entered from an infrared keyboard, with or without entering other criteria.

If the keyword search is activated without entering other criteria, the default values of these criteria are used.

### Navigation on the Screen

The first focus is on the keyword entry area. The concept of focus covers any specific display variation of an active or activated selection area of the screen.

Using the Right and Left arrow keys, the focus moves to “Channels”, then “Themes”, then “Days”, then “Times” and finally “Enter” to start the search.

Confirming one of the criteria (Channels, Themes, Days, Times) triggers the updating of the list of possible values for this criterion. Navigation in this list is done via the up and down arrows.

Activating or deactivating one of these values is done using the [symbol] button of the remote control.

### “Channel” Criterion

The corresponding screen is shown in FIG. 4.

The set of channels received by the user's terminal is shown.

Several channels may be selected. A focus is positioned on each channel name chosen: [symbol] on remote control for removing the focus, [symbol] again to reset it.

By default, the whole set of channels is taken into account (“all channels” value).

### “Theme” or Thematic Subject Criterion

The corresponding screen is shown in FIG. 5.

The set of themes received by the user's terminal is shown.

Several themes may be selected. A focus is positioned on each theme name chosen: [symbol] on remote control for removing the focus, [symbol] again to reset it.

By default, the whole set of themes is taken into account (“all themes” value).

### “Day” Criterion

The corresponding screen is shown in FIG. 6.

### Description of the Screen

The choices offered are: all days (7 days), today, tomorrow and from Monday to Sunday.

By default, the whole set of days is taken into account (“all days” value).

### “Time” Criterion

The corresponding screen is shown in FIG. 7.

### Description of the Screen

The choices offered are “now” and 8 time slots of 3 hours each, starting from 2 o'clock in the morning:

Now (default configuration) Afternoon (5 p.m.-8 p.m.)

Morning (5 a.m.-8 a.m.) Evening (8 p.m.-11 p.m.)

Morning (8 a.m.-11 a.m.) Night (11 p.m.-2 a.m.)

Midday (11 a.m.-2 p.m.) Night (2 a.m.-5 a.m.)

Afternoon (2 p.m.-5 p.m.)

Several time slots may be selected. A focus is positioned on each time slot chosen: [symbol] on remote control for removing the focus, [symbol] again to reset it.

By default, the whole set of days is taken into account (“all times” value).

### Starting the Search

In the screen for starting the search shown in FIG. 4, the criterion or criteria already confirmed are shown in a different graphic style.

The search can be started at any phase of criteria definition; the criteria taken into account will be those chosen by the user or the default values for criteria not entered.

During a search by user-specified keyword, the terminal 3 analyzes all the text data stored in the array obtained in step 12, with the associated URLs. The terminal 3 then displays an event corresponding to an event whose presence is verified by the analysis carried out by the terminal 3.

### Result of the Search

The result of the search is shown in the form of a list of tags (first-level text information on programs and thumbnail images). As shown in FIG. 8, the list of tags can be displayed in the form of a ticker tape. This preferred but non-restrictive method of display enables the user to make a preliminary check on and selection of the results of the search by user-initiated scrolling of the images or tags. For a more detailed description of the ticker tape display, it may be useful to refer to French patent application FR0011407 filed on Sep. 7, 2000.

The screen display shows the program or programs selected.

A client system can be used to access supplementary information relating to the selected program. Using the remote control the following can be viewed:

the program data sheet,

a summary,

a review,

a trailer.

The corresponding query to the server uses the URL stored with the selected event.

The simultaneous display on the screen and in the form of a thumbnail image of the program (as a “picture in picture”—PIP) is possible for programs in progress by an operation on the remote control.

A new search can be started from this screen.

The method according to the invention and the system implementing it can be used to quickly access supplementary information such as images, trailer, film reviews or others, whose access URL in the database 2 is known to the terminal 3 thanks to the stored array that associates this URL with an audio-visual program event specified by the user. The invention therefore offers a richer televisual alternative than a traditional paper TV guide and one that is more powerful than a conventional electronic guide.

### Appendix 1

### Description of Event Tables (Event Information Table, EIT)

The EIT tables provide the list of events (broadcasts) relating to each current multiplex service (Actual transport stream EIT) or other multiplexes (Other transport stream EIT), and the characteristics of each of these events (start and duration of the broadcast, list of descriptors associated with the event).

The events are identified by the identifier quadruplet Original_Network_id/Transport_Stream_id/Service_id/Event_id.

EITs are of two types:

present/following EITs providing information on the event in progress and the next event,

schedule EITs for describing the future events of a service in a time span ranging up to 64 days.

The presence of Actual transport stream present/following EITs is compulsory in each multiplex.

The presence of Other transport stream present/following EITs and schedule (Actual and Other transport stream) EITs is optional.

In the DVB SI standard EN 300 468:

Event Information Table (EIT):

EITs contain data concerning events or programs such as: event name, start time, duration, short event descriptor, extended event descriptor, content descriptor, etc.

1. Search method for audio-visual programs or contents on an audio-visual flux containing tables of events distributed by a database, characterized in that it consists in establishing a search criterion for such programs or contents consisting of a combination of all or part of the search arguments such as keywords, search themes, television broadcasting channel, day, broadcast time.

2. Method according to claim 1, characterized in that complementary data being associated with said events contained in said event table, it consists in extending the search field of the search argument by keywords to said complementary data associated with each event.

3. Method according to one of claims 1 or 2, characterized in that for a database comprising multimedia contents, said multimedia contents associated with an event are linked to the event selected by a URL-type link stored in an event table, which enables direct access to be established to said associated multimedia contents via the event tables.

4. Method according to one of claims 1 to 3, characterized in that it further consists in displaying images obtained based on said search criterion in the form of a ticker tape, enabling the user to make a preliminary check on and a selection of the results of the search by user-initiated scrolling of said images.

5. Search method for audio-visual programs or contents on an audio-visual program flux, characterized in that it consists in combining a search by keyword in different fields of event tables broadcast in the audio-visual program flux with a search by program guide criteria of the Theme, Channel, Day, Broadcast Time type, whose values are defined in said event tables, for accessing textual contents of a database accessible via an interactive link.

6. Method according to claim 5, characterized in that complementary data being associated with said events contained in said event table, it consists in extending the search field of the search argument by keywords to said complementary data associated with each event.

7. Method according to one of claims 5 or 6, characterized in that for a database comprising multimedia contents, said multimedia contents associated with an event are linked to the event selected by a URL-type link stored in an event table, which enables direct access to be established to said associated multimedia contents via the event tables.

8. Method according to one of claims 5 to 7, characterized in that it further consists in displaying images obtained based on said search criterion in the form of a ticker tape, enabling the user to make a preliminary check on and a selection of the results of the search by user-initiated scrolling of said images.
